(19) United States
(12) Patent Application Publication
(10) Pub. No.: US 2018/0259710 A1
(43) Pub. Date: Sep. 13, 2018

(54) Wafer-Scale Polymer-Aided Light Coupling for Epitaxially Grown Material Platforms

(71) Applicant: Technische Universiteit Eindhoven, Eindhoven (NL)

(72) Inventors: Ripalta Stabile, Eindhoven (NL); Nicola Calabretta, Berkel-Enschot (NL)

(21) Appl. No.: 15/974,221

(22) Filed: May 8, 2018

Related U.S. Application Data
(63) Continuation-in-part of application No. 15/897,812, filed on Feb. 15, 2018.
(60) Provisional application No. 62/459,375, filed on Feb. 15, 2017.

(51) Int. Cl. G02B 6/122

(52) U.S. Cl. CPC G02B 6/1228; G02B 6/131

(57) ABSTRACT

An optical waveguide coupler is provided that includes an InP substrate, a guiding core layer disposed on the InP substrate, a top cladding layer disposed on the guiding core layer, where the guiding core layer and the top cladding layer are disposed in a photosensitive housing waveguide, and a mode coupling region having a lateral taper of the guiding core layer and the top cladding layer disposed above a region where the InP substrate is at least partially removed to create an air-cladding, where a low-to-high refractive index contrast transition (RICT) InP-based waveguide device is established to minimize light leakage into the InP substrate.

### CROSS-REFERENCE TO RELATED APPLICATIONS

This application is a continuation-in-part of U.S. patent application Ser. No. 15/897812 filed Feb. 15, 2018, which is incorporated herein by reference. U.S. patent application Ser. No. 15/897812 claims priority of provisional patent application 62/459375 filed Feb. 15, 2017, which is incorporated herein by reference.

### FIELD OF THE INVENTION

The invention relates generally to optical waveguide couplers. More particularly, the invention relates to a device that enables relaxed alignment tolerance and low-loss light coupling for InP-based I/O waveguides.

### BACKGROUND OF THE INVENTION

The use of an indium phosphide (InP) material-based platform is generally preferred for complex integrated circuits requiring light generation, modulation, amplification and fast switching on one single chip. While the rapid developments in ‘generic’ and dedicated integration technologies have led to a dramatic reduction of photonic integrated circuit (PIC) designs and manufacturing costs, those have not been followed by a similar trend in packaging and testing costs yet. The lack of a cheap and low loss methods to assemble optical InP inputs/outputs (I/Os) also impacts the chip performance: optical losses and optical signal to noise ratio (OSNR) degradation increase mostly due to the high coupling losses and per-fiber alignment tolerances in the order of sub-microns. A key drawback is the relatively small and rectangular dimensions of the guiding InP core of several hundred nanometers height and about 1.5-2 μm width. This is in general directly butt-coupled to a standard optical single mode lensed fibre with a circular core of about 10 μm diameter: this large mode size mismatch produces a large coupling loss that can be higher than 3.0 dB for a position accuracy within ±0.25 μm. Moreover, the large facet reflections (the refractive index of the fiber is about 1.47, and that of the core InP waveguide is about 3.36) at the connection induces a fatal Fabry-Pérot resonance, which degrades the optical spectral profile characteristics. Finally, when moving from a single to multiple fibers, other issues like fiber core eccentricity and fiber misalignment (0.5 μm best-in-class misalignment) add up to the already strict per-fiber alignment tolerances.

Very recently, a photonic wire bonding technique has been developed, which enables low-loss single-mode connections between the chip input/output waveguide and a single mode fiber, but this is intrinsically a serial solution. On-chip spot-size converters on multi-layer epitaxial grown InP wafers have been proposed, which provide a total coupling loss of 1.5 dB with 3 dB displacement tolerances of a few μm, but they require complex epitaxial growth and expensive techniques for 3D patterning the 200 μm long spot-sizes. Etched facets and vertical couplers have been investigated, but these solutions do not mitigate the mode mismatch losses between the InP waveguide and the single mode fiber, which makes them suitable only for on-wafer testing of the photonic devices. We have recently proposed the very first attempt to solve multiple I/Os InP chip interfacing, based on the new concept of on-chip auto-alignment: this device is 1.3 mm long and involves active alignment, for a displacement tolerance of 0.8 μm at most and only for the horizontal axes. However, passive alignment is highly desirable. A comprehensive analysis of the proposed implementations for fiber-to-chip passive light-coupling in silicon photonics highlights how these solutions do not represent a viable approach for a lower vertical refractive index contrast (RIC) material platforms, such as the InP-based platform, because of light leaking into the bottom InP cladding layer.

What is needed is a device that enables relaxed alignment tolerance and low-loss light coupling for InP-based I/O waveguides.

### SUMMARY OF THE INVENTION

To address the needs in the art an optical waveguide coupler is provided that includes an InP substrate, a guiding core layer grown on the InP substrate, a top cladding layer grown on the guiding core layer, where the guiding core layer and the top cladding layer are disposed in a photosensitive housing waveguide, and a mode coupling region having a lateral taper of the guiding core layer and the top cladding layer disposed above a region where the InP substrate is at least partially removed to create an air-cladding, where a low-to-high refractive index contrast transition (RICT) InP-based waveguide device is established to minimize light leakage into the InP substrate.

According to one aspect of the invention, the photosensitive housing waveguide includes a photosensitive polymer material.

In another aspect of the invention, the lateral taper of the top cladding includes a fixed height, or a stepped height along a length of the top cladding layer.

In a further aspect of the invention, a boundary of the partially removed region of the InP substrate includes a vertical boundary or an angled boundary.

In yet another aspect of the invention, the guiding core layer includes InGaAsP.

According to one aspect of the invention, the top cladding layer includes InP.

In a further aspect of the invention, the photosensitive housing waveguide is disposed in a pattern on top of the InP-based waveguide.

In another aspect of the invention, optical coupling is enabled by reducing a width of the guiding core layer and a width of the top cladding layer down to a fundamental mode cut-off condition of a guided beam, and by locally removing the bottom portion of the InP substrate layer between the input waveguide and a tip of the reduced width.

According to one aspect of the invention, a guided beam that is output from a tip of the guiding core layer is disposed to couple into a wider cross-section of the photosensitive housing waveguide and into a cleaved fiber.

In a further aspect of the invention, the lateral taper of the guiding core layer and the top cladding layer enable adiabatic coupling into the photosensitive housing waveguide, whereby broadband operation of the InP-based waveguide device is preserved.

In yet another aspect of the invention, the lateral taper of the guiding core layer is configured to force a mode of a guided beam up into the photosensitive housing waveguide.

### BRIEF DESCRIPTION OF THE DRAWINGS

FIGS. 1A-1H show schematic drawings of embodiments of the InP-based waveguide, input (1C) and output (1D) cross-sections of the low-to-high RICT device, according to the current invention.

FIG. 2 shows the effective refractive index for the fundamental TE0 and TM0 mode for the input (empty circles) and output (filled circles) waveguide cross-sections of the RICT device, according to the current invention.

FIGS. 3A-3F show intensity mode profiles for the fundamental modes TE0 (3A-3C) and TM0 (3D-3F), for different InP top cladding thicknesses, for a standard InP waveguide. A thermal-negative and normalized color scheme is used, where the black color indicates the 0 level and the white color the 1 level, according to the current invention.

FIGS. 4A-4B show schematic drawings of (4A) a top view of the taper design, including the four waveguide sections. (4B) Details of the cross-sections for the RICT device, according to the current invention.

FIG. 5 shows the InP/air bottom cladding interface placement scanning for minimized reflections, according to the current invention.

FIGS. 6A-6E show the top views of the xz intensity profile were taken at different depths: (6A) at a depth of 0.25 μm, the light is guided by the InP core layer waveguide; (6B) at a depth of 1 μm, the light couples into the top InP layer and then spread out of it; (6C) at a depth of 1.5 μm, the light couple into the polymer waveguide with 3 μm×3 μm cross-section. Beam propagation side view along the entire RICT device (6D) and mode profile at the final polymer waveguide cross-section (6E), according to the current invention.

FIG. 7 shows the transmitted optical power as a function of the wavelength over 300 nm wavelength range, according to the current invention.

FIGS. 8A-8B show schematic (top views) of the fabrication process steps for the conceived I/O transition devices (8A). Lateral view of two opposite free-standing waveguides (8B), where the undercut profile is made steep for ease of understanding. The dashed line indicates the dicing/cleaving placement, according to the current invention.

FIGS. 9A-9B show the fabrication error tolerance for the case of a misalignment of the polymer waveguide on top of the InP waveguide (9A) and for the case of a taper tip width definition variation (9B), according to the current invention.

### DETAILED DESCRIPTION

The current invention is a passive low-loss optical coupling, which is compatible with the ‘generic’ indium phosphide (InP) multi-project-wafer manufacturing. According to one aspect of the invention, a low-to-high vertical refractive index contrast transition InP waveguide is designed and tapered down to adiabatically couple light into a top polymer waveguide. In another aspect, an on-chip embedded polymer waveguide is engineered at the chip facets for offering refractive-index and spot-size-matching to silica fiber-arrays. A numerical analysis provided herein shows that coupling losses lower than 1.5 dB can be achieved for a TE-polarized light between the InP waveguide and the on-chip embedded polymer waveguide at 1550 nm wavelength. Coupling losses lower than 1.9 dB can be achieved for a bandwidth as large as 200 nm. Moreover, the foreseen fabrication process steps are indicated, which are compatible with the ‘generic’ InP multi-project-wafer manufacturing. A fabrication error tolerance study is performed, indicating that fabrication errors occur only in 0.25 dB worst case excess losses, as long as high precision lithography is used. The current invention is useful for providing large port counts and cheap packaging of InP-based photonic integrated chips.

In one aspect, the current invention provides a device that enables relaxed alignment tolerance and low-loss light coupling for InP-based I/O waveguides, based on the implementation of an on-chip integrated transition from low-to-high refractive index contrast waveguide, in combination with an on-chip embedded polymer I/O waveguide. According to one embodiment, the device includes adiabatic coupling of light from a standard InP waveguide into a wider cross-section polymer waveguide and on the presence of a bottom air-cladding. While the optical coupling loss between a polymer waveguide with a 3×3 μm² cross-section and a lensed SWF has been already measured to be lower than 0.4 dB, the current invention is directed to the minimization of the insertion loss enabled by the invention. Disclosed herein is the modal content at the input and at the output of the low-to-high refractive index contrast transition (RICT) device is carried out by looking at the cut-off conditions and at the minimized light leakage into the substrate. A multiple stage multiple-layer taper is then provided for enabling a low loss adiabatic coupling. Light propagation in the RICT device is simulated for calculating insertion losses of the InP-to-polymer waveguide transition.

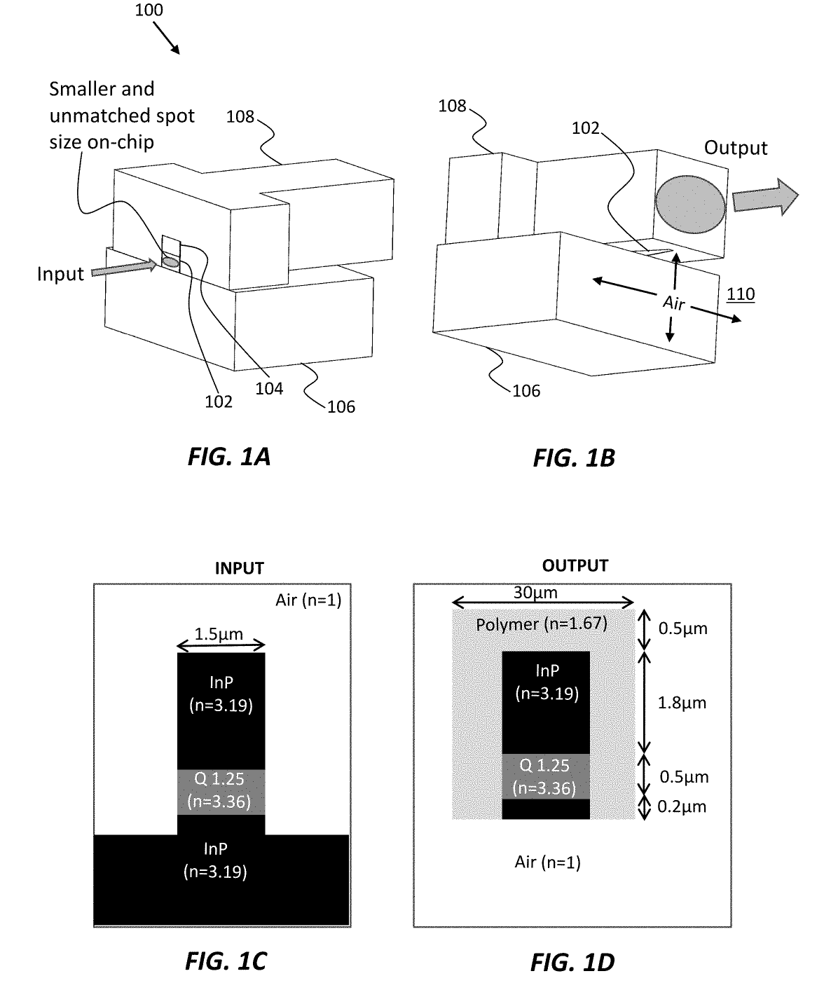

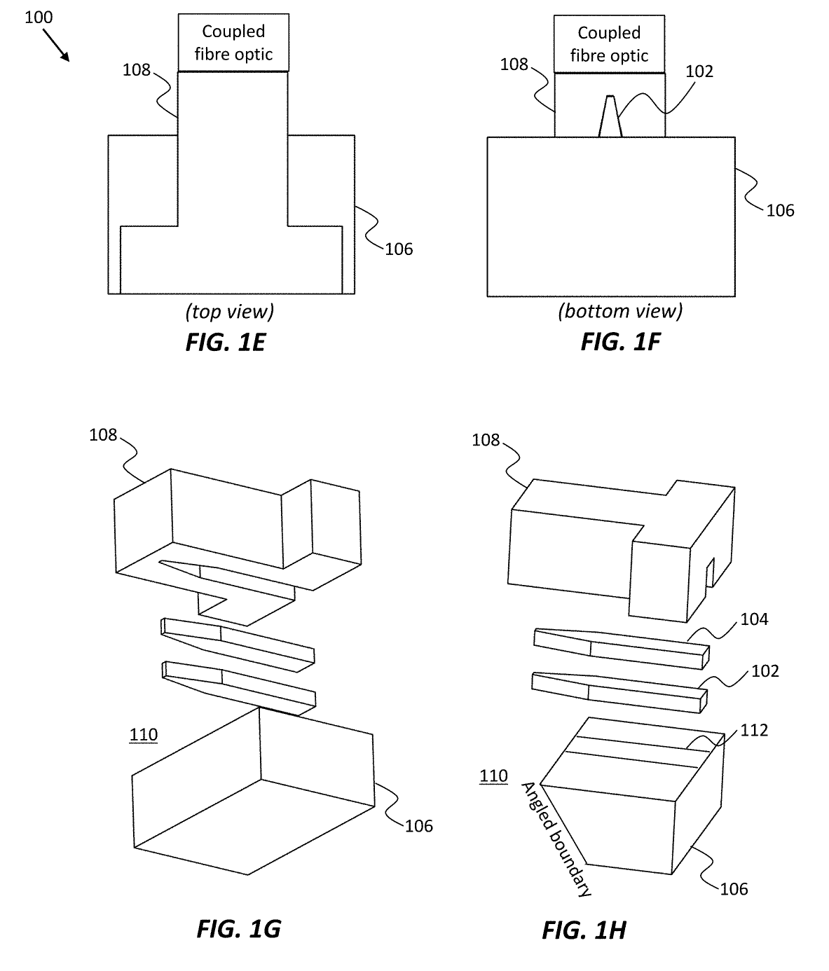

According to one embodiment, the invention allows low-loss optical coupling of InP-chips by equipping I/O InP waveguides with overhanging wider polymer waveguide and a bottom air-cladding. The choice of using the polymer waveguide is justified by the need to provide low-cost coupling and patterning flexibility. Also, the interfacing polymer waveguide offers refractive index matching to the silica-fibre cores preventing optical reflections. Light coming from the InP-based waveguide is forced to adiabatically couple to the polymer waveguide patterned on top. This is only possible if the InP waveguide is equipped with a vertical high refractive index contrast, where provided herein is locally defining a bottom air-cladding at the InP standard waveguide, in order to prevent light from leaking into the substrate. FIGS. 1A-1H show schematic drawings of embodiments of the

InP-based waveguide 100, where the guiding core layer 102 is the InGaAsP core layer, while the top cladding layer 104 and substrate layer 106 are InP cladding layers. Further shown is the InGaAsP core layer 102, while the top cladding layer 104 is housed by a photosensitive polymer housing 108 that is patterned on top of the InP-based waveguide 100. The polymer waveguide 108 is co-embedded on top of a tapered-down InP waveguide section 104 and core layer section 102, whose final tip of the InP waveguide 100 hangs on top of the bottom air-cladding 110. FIG. 1H further shows an embodiment of the invention where there is an InP layer 112 (˜2 μm for example) disposed on the substrate layer 106, where the boundary for the substrate layer 106 is an angled boundary.

Adiabatic vertical coupling of light from the InP waveguide into the polymer top waveguide must be ensured. Since the polymer waveguide refractive index is lower than that of the InP core waveguide, such coupling is made possible by reducing the InP waveguide width down to the fundamental mode cut-off condition and by locally removing the bottom InP cladding layer, treating it as a sacrificial layer. Light, after escaping the tapered-down small-core suspended InP waveguide, couples into the wider cross-section polymer waveguide and finally into the cleaved fiber. The InP waveguide, tapering down for adiabatic coupling into the polymer waveguide, is expected to preserve broadband operation of the device.

The influence of the waveguide width on the mode guidance for the RICT device is disclosed herein for both the input and output cross-sections of the transition device. A semi-analytical fully vectorial waveguide solver from FIMMWAVE (PhotonDesign) is used to calculate the mode of the InP waveguide and the cut-off widths. In order to inspect a deep etched InP-based waveguide, two parameters are used to inspect whether the mode is guided or radiated: (1) the effective refractive index: if it is larger than the refractive index of the cladding layers, the mode is confined and therefore guided. (2) the confinement factor: a guided mode will typically have a high confinement factor value, whilst a radiation mode will have a much smaller value. It is not possible to give a definite range of values that make a mode qualified as guided or radiative, but this parameter is useful when studying single mode conditions, since the transition from guided to radiative appears very clearly with a sharp drop in confinement factor.

In the process of simulating the light propagation through the final device, the modal content of the RICT device at its input and output was investigated. The influence of the top InP cladding layer thickness on the mode profiles was studied. This analysis provides part of the guidelines on how to design the complete device.

Turning now to the input waveguide: the input and output waveguide cross-section of the RICT device is shown in in FIGS. 1C-1D, respectively. A standard generic rectangular deep etched waveguide having a quaternary (Q) alloy InGaAsP, the core, with refractive index 3.36, is sandwiched between two cladding layers of InP of refractive index 3.19. The Q layer guides the light. At the RICT output, however, the core is sandwiched between one top cladding layer of InP and the bottom air-cladding with refractive index 1.

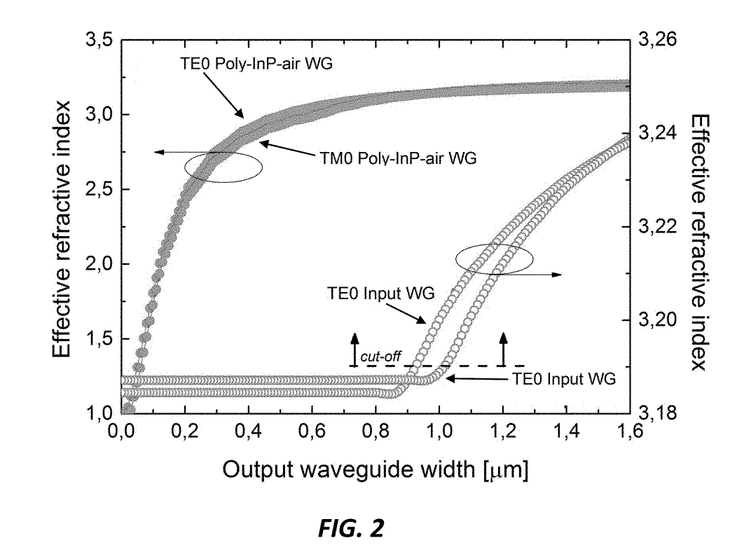

The cut-off mode width is inspected by scanning the waveguide width from 1.5 μm down to 0 μm with steps of 10 nm and by recording the effective refractive index. Note that for an effective refractive index lower than 3.19 the mode is radiated. This inspection is limited to the fundamental TE and TM modes for this input waveguide cross-section since they are the only modes guided in a deep etched waveguide with 1.5 μm width in the InP generic platform. FIG. 2 (empty circle curves) shows the modal computation results in terms of effective refractive index for the input waveguide cross-section. The fundamental TE mode (TE0) cut-off is found to be at 0.92 μm, where the confinement factor drops from 72% down to 0%. The fundamental TM mode (TM0) cut-off width is found to be at 1.02 μm width, instead: the calculated confinement factor for this mode drops from 67% down to 0% at this width value. When the polymer layer is added on top of the waveguide, the vertical effective refractive index is expected not to change significantly since the polymer refractive index is most likely close to the refractive index of the air. A refractive index of 1.67 was assumed here for the case of polyimide (PI) polymer. This is already used in the ‘generic’ InP technology for InP chip planarization. Therefore, a waveguide width scan is later executed for a cross-section where both the polymer waveguide on top and the bottom air-cladding are added.

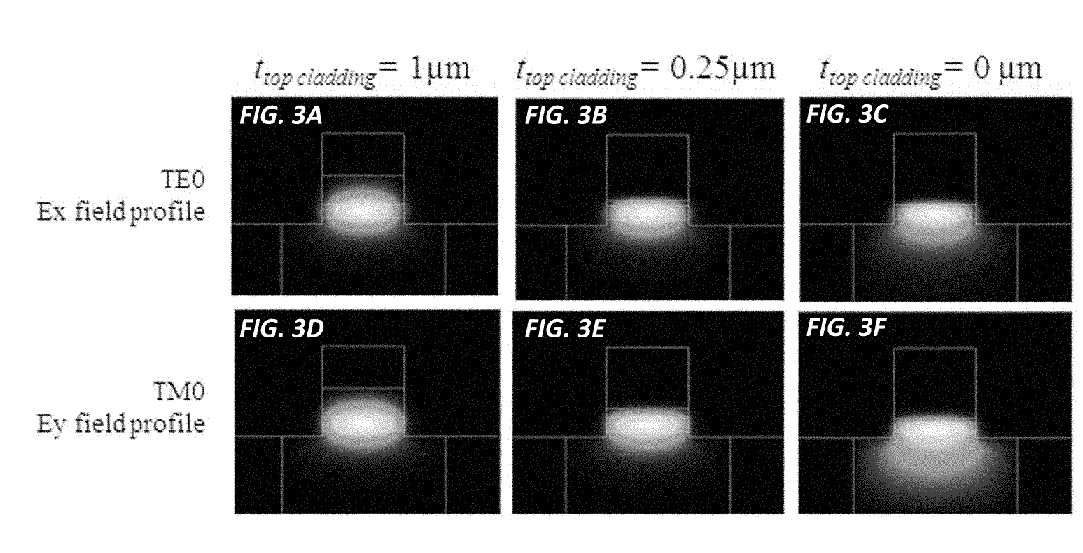

Regarding the top InP cladding, one aspect of the current invention is the coupling of light into the top polymer waveguide through adiabatic coupling. This anticipates the need of tapering down the waveguide to force the mode up into the polymer waveguide. However, the presence of a thick top InP cladding forces the generation of multiple modes when tapering down the device waveguide width. Turning now to investigating the effect of the thinning of the top InP cladding of a standard InP waveguide for both the TE and TM fundamental modes, before removing the bottom InP cladding. FIGS. 3A-3F show the intensity profiles for both the TE and TM fundamental modes of a standard deep-etched InP waveguide cross-section for different top cladding thicknesses. It clearly shows that the more the top InP cladding is thinned, the more the modes are pushed down into the substrate: removal of the InP cladding before the low-to-high RICT device would then exacerbate the losses and the bottom InP/air interface. Therefore, the top InP cladding will not be removed. If on one hand this will make it difficult to maintain single-mode operation, on the other hand, it is believed to facilitate transferring light power into the polymer top waveguide.

For the bottom air-cladding, it is fundamental to investigate what are the modal content and the cut-off widths of a standard InP waveguide when removing the bottom InP cladding. The waveguide cross-section is now very different from the previous input waveguide cross-section (see FIG. 1D). This is untapered, but the vertical refractive index contrast is now as high as 0.4, one order of magnitude higher than in the case of an InP bottom cladding (Δn˜0.04). As a consequence, the waveguide with a 1.5×0.5 μm² cross-section hosts tens of modes, among those there are the fundamental and TE and TM higher order modes, quasi-TE and quasi-TM modes, as well as super-modes excited at the InP/Q dual layer, which will not be analyzed in this disclosure. However, the multi-mode operation is clearly suggested by FIG. 2 (filled circle curves): the fundamental TE and TM modes are present almost all over the width scanned values. In particular, the confinement factor is found to be 73% and 63% respectively for the TE0 and TM0 modes still at 150 nm waveguide width. The waveguide width must be narrowed to get down to few modes propagation and facilitate excitation of single mode operation in the top placed polymer waveguide. This will be discussed through light propagation analysis in the complete device below.

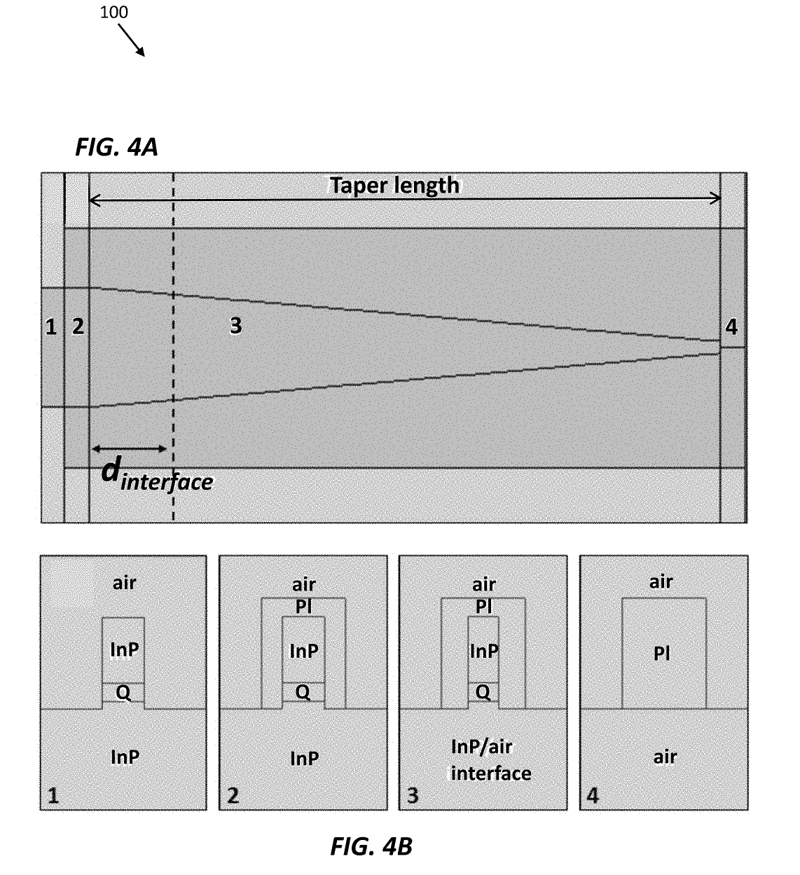

The RICT device according to the current invention is possible by means of light propagation investigation through the widely used propagation tool for modelling and simulating optical waveguides FIMMPROP (PhotonDesign). The goal is to smoothly adapt the mode from the input to the output cross-sections, guiding the light with very low losses and with an optimal device length in order to achieve the desired spot-size. One example of the device is studied at a wavelength of 1.55 μm. As the fundamental TEO and TM0 mode can still travel up to a width of about 1 μm, in order to guarantee the waveguide stays in single mode operation, the width is reduced to a maximum value of 1 μm before removing the substrate. Then, the InP substrate is removed and further narrow the cross-section width down to the cut-off width in order to force light coupling into the polymer waveguide. Therefore, the RICT device will be composed of several waveguide length sections, connected with joints, in which the overlaps between the modes of each section are calculated by the software. FIG. 4A shows the top-view of the RICT device, including the four waveguide sections. More specifically, the device will include the following sections: (1) The standard input InP waveguide with a width is fixed at 1.5 μm and the length set at 10 μm (FIG. 4B, cross-section 1). (2) The standard InP waveguide with a polymer waveguide on top: since it has negligible impact on the device performance, its length is also set at 10 μm (FIG. 4B, cross-section 2). (3) The 250 μm long InP taper, including the substrate InP/air interface: its waveguide width is linearly changed from 1.5 μm down to 150 nm (which is approximately the minimum resolution achievable by using a high-precision lithography tool for this taper definition) (FIG. 4B, cross-section 3). (4) The polymer waveguide with length of 30 μm and a 3×3 μm² cross-section (FIG. 4B, cross-section 4).

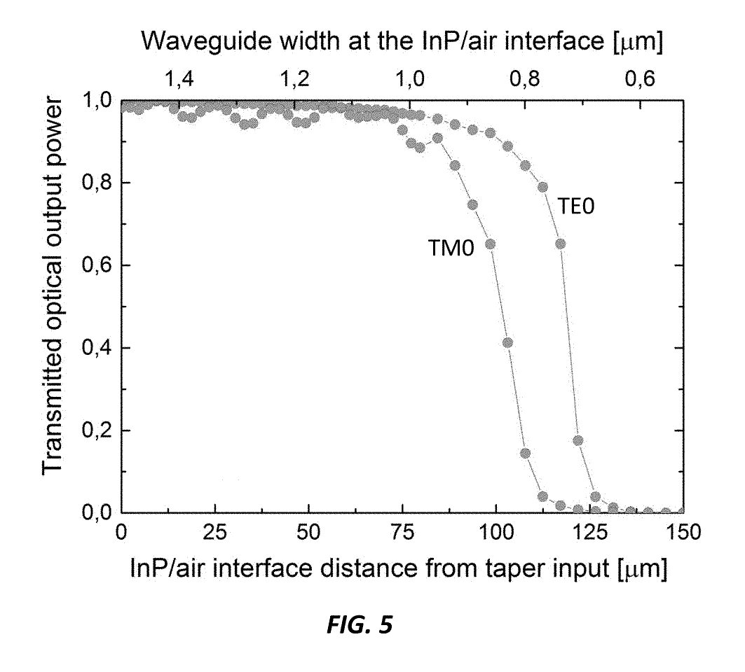

The fundamental TE and TM modes are launched at the input of the standard InP waveguide. The bottom InP cladding is then etched away and, at the same time, the waveguide is taper-down to force light adiabatically coupling to the final polymer waveguide section. The bottom cladding InP/air interface placement is scanned over the first 150 μm of the taper section for identifying the point (d_{interface} in FIG. 4A)) of minimal light reflections and maximum output power. The transmitted net optical power is calculated at the taper output and displayed in FIG. 5. The curves correspond to the calculated transmitted power over the TE and TM fundamental modes present at the tip of the taper. The optical power for the TE0 curve halves already at around 100 μm, where the taper width is 0.85 μm. This happens because the narrower the width, the more the modes radiate, causing reflections at the InP/air interface. This optical loss is visible also when using the Power Diagnostic instrument of the propagation tool. Most of the losses happen at the InP/air interface, if it is placed at 100 μm away from the taper input. Here, the loss goes up to 43% in correspondence of the interface. The placement of the interface at 70 μm distance from the input taper (at a correspondent width of 1.05 μm) incurs about 9% losses instead, which allows us to keep the optical losses within the 1 dB level.

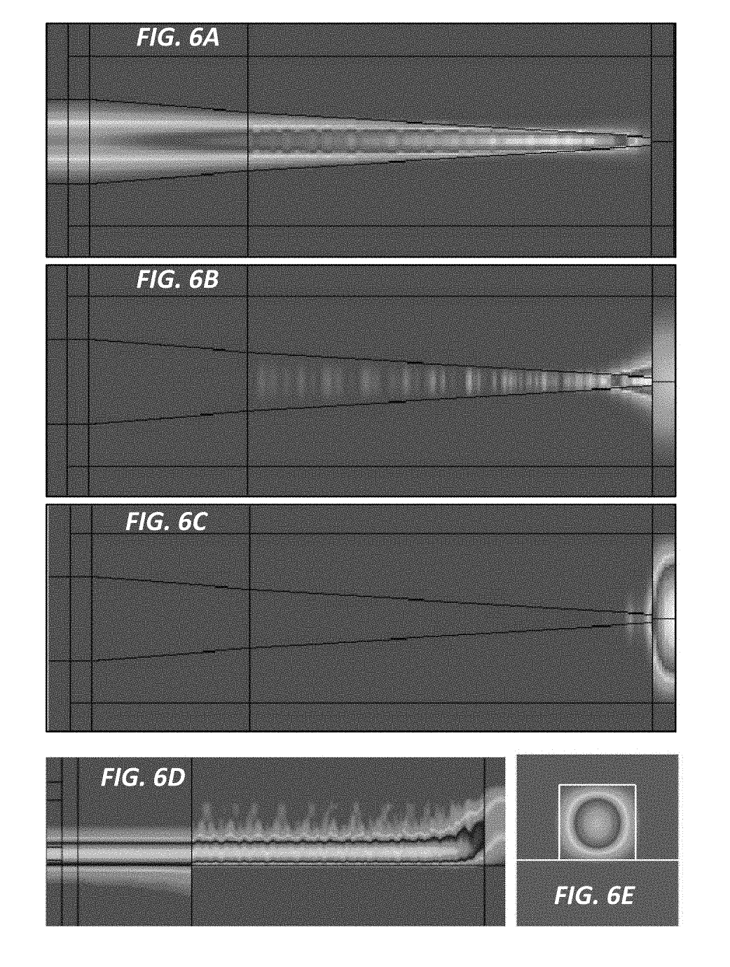

Finally, in this example, the device parameters are set as: 250 μm taper length, InP/air interface placed 70 μm far from the taper input, 150 nm output taper width, InP top cladding thickness fixed at 1.8 μm. In FIGS. 6A-6E, the top views of the xz intensity profiles for a TE fundamental mode input are taken at different depths to show how the light couples into the polymer waveguide. The intensity plots in the xz plane are taken at depths y which are relevant to show how light is transmitted moving from the input InP waveguide into the polymer waveguide: the first intensity plot shown in FIG. 6A is taken at a depth, which corresponds to the center of the Q active layer (0.25 μm). The third intensity plot in FIG. 6C is taken at a depth, which corresponds to the center of the polymer waveguide (1.5 μm). The intensity plot in FIG. 6B is taken at an intermediate depth (1 μm) to show how the coupling is happening. The beam propagation side view is also displayed in FIG. 6D to show where and how the light coupling into the polymer waveguide is happening: this happens starting from a taper width of about 500 nm. While reducing the taper width further, the light is coupled into the polymer waveguide: the mode profile of the polymer waveguide in the xy plane is now displayed in FIG. 6E. These plots are reported for the TE mode only: generic InP circuits are generally designed for working with TE-polarized light. According to the scattering matrix of this device, 67.9% of the TE0 input light is coupled into the TE0 mode of the polymer waveguide, and some small % couples into higher order modes, for a total loss of 29%. A similar number is also calculated by the Power Diagnostics function: the losses first occur where the substrate is removed (9%). The loss goes up to a total 29% (20% more losses) at the interface between the InP tip and the polymer.

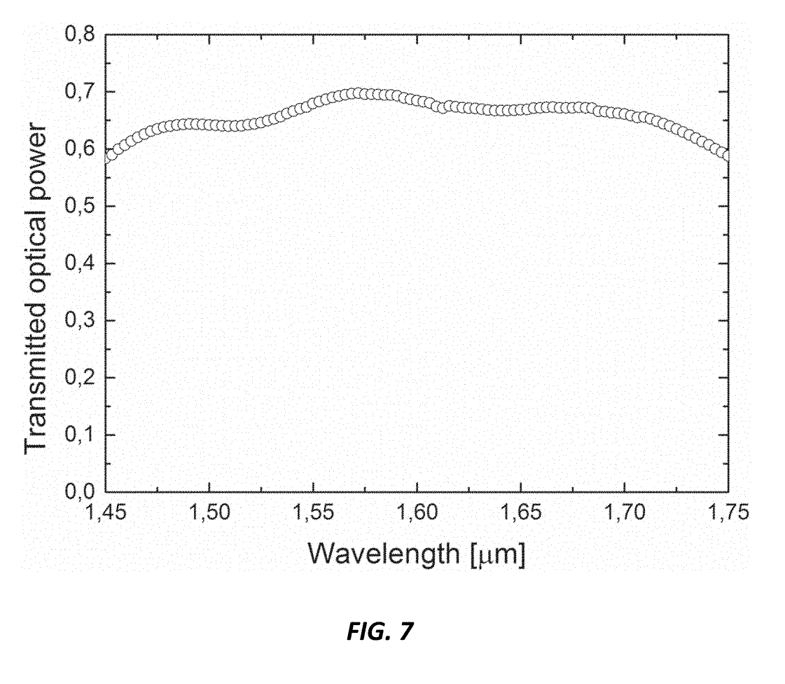

While the losses at the interface were controlled, more investigation is needed for trying and keeping single mode operation in the waveguide before moving into the polymer waveguide. However, a calculated insertion loss lower than 1.5 dB for a TE-polarized light shows that this technique is very promising. Suggestions are explained below on how to improve the RICT device performance even further. Finally, the forced adiabatic coupling has been reported to be wavelength independent. This is now confirmed for this case too: the transmitted optical power as a function of the wavelength is reported. FIG. 7 shows that the 1 dB waveband is far larger than 300 nm. Specifically, coupling losses lower than 1.9 dB can be achieved for a TE-polarized light for a bandwidth as large as 200 nm. This intrinsic behavior is promising for wavelength division multiplexing based circuit operation.

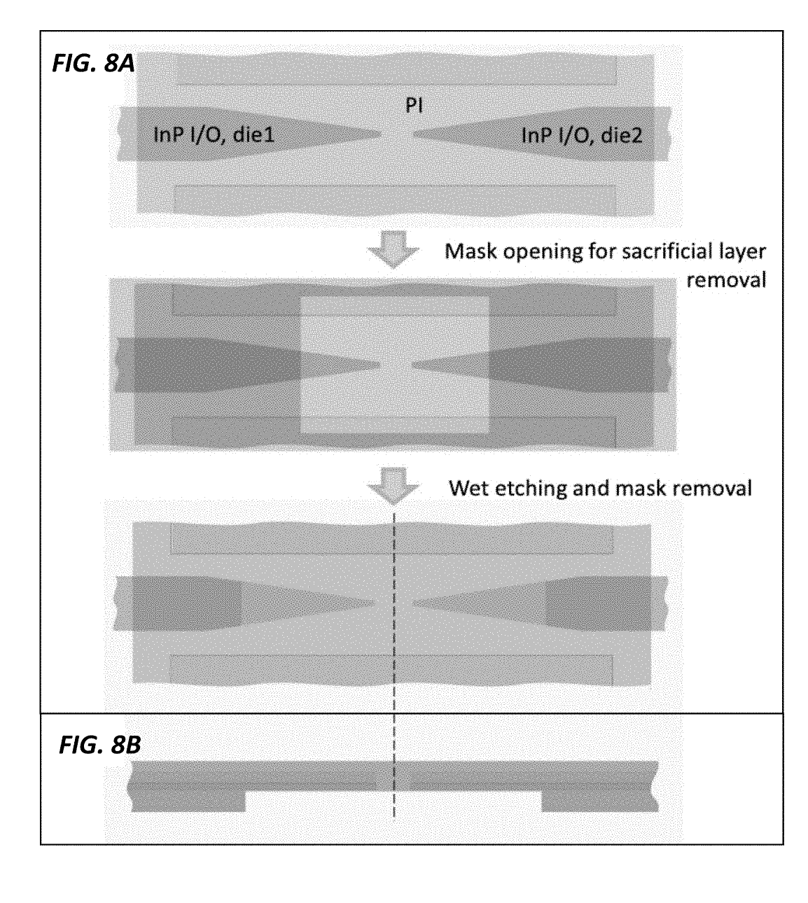

Turning now to the fabrication process flow and tolerances. The results of the device in the current invention are compatible with the ‘generic’ InP technology since it is thought to be realized at the end of the wafer processing and just before cleaving. When realizing the tapered down I/O InP waveguides at the die facets, these, belonging to the neighboring dies, are fabricated one in front of each other at a certain distance. The technology based on the sacrificial layer wet etch is used: in this case, the sacrificial layer is the InP bottom cladding. According to one embodiment, a possible fabrication process flow for this device is proposed and schematized in FIG. 8A. With the PI planarization step of the ‘generic’ technology, the final polymer waveguides on top of the InP waveguide (dark blue parts) are already realized. Afterwards, a mask layer is deposited on the overall wafer, and squared areas are opened in correspondence of the area where the reason of wet etching of the sacrificial layer is to release the PI waveguide bridge between two adjacent die cells (FIG. 8B). A combination of dry and anisotropic wet etches might be used to reach the bottom InP cladding and hit the d_{interface} point precisely. The InP bottom cladding layer is first reached by carrying out a CH₄:H₂ ICP dry etching (InP etch rate of 70 nm min−1 and Q etch rate of 45 nm min−1). Then, a pivotal InP anisotropic wet etching is carried out to create the inverted-mesa-like structure. Two possible solutions are identified for this step: An HCl:CH₃COOH solution in the ratio 1:4 (InP etch depth rate of 0.9 μm min⁻¹) or an HCl:H₃PO₄ solution in the ratio 1:3, where the InP underetching rate rapidly decreases with a lower HCl content down to 0.1 μm min⁻¹ for a better under-etching control. Both solutions are InP selective with respect to the quaternary InGaAsP layer and dependent on the device orientation with respect to the (011) cleaved plane. The polyimide waveguide itself can be used as a mask.

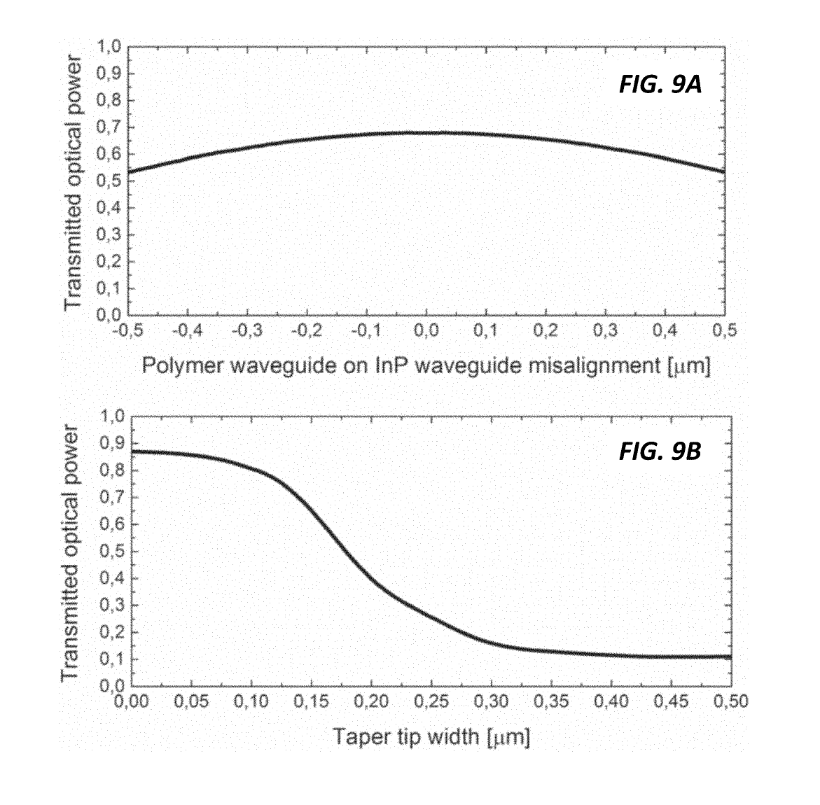

In the foreseen fabrication process flow, there are three possible sources of error: (a) the polymer waveguide on top of the InP waveguide misalignment is studied and reported in FIG. 9A. A maximum loss of 1 dB is found for a worst-case misalignment of ±500 nm through photolithography. This number is brought down to 0.25 dB worst case loss when using deep-UV lithography. (b) A second source of fabrication error can be derived from the realization of the narrow taper tip: the transmitted optical power is now studied as a function of the taper tip width (see FIG. 9B). The best simulation results are achieved for a tip which tends to zero. In our final device, this has been kept fixed to a minimal value of 150 nm, which is considered to be achievable when using high-resolution lithography techniques. (c) A last source of error derives from the d_{interface} placement, which has already been analyzed above. As long as the InP bottom cladding layer is etched for a distance which is longer than 180 μm, the losses are kept under control. Overall, the fabrication errors do not add up to notable additional losses as long as high precision lithography is used.

The current invention incorporates an InP generic platform with a low-to-high RICT device to couple its input light into a top polymer waveguide for making a leap forward into relaxed alignment tolerances and low-coupling losses of InP based chips to the outside fibers. Initial investigations are carried out to provide the polymer-aided low loss coupling, obtaining an insertion loss of the proposed RICT device of less than 1.5 dB for a total InP-to-fiber power coupling loss of less than 1.9 dB for a TE-polarized light. The performance is mainly limited by the difficulty to control single-mode operation after removal of the bottom InP cladding. Nonetheless, it is foreseen to improve by using parallel strategies, like the use of multiple-polymer layers for facilitated adiabatic coupling, or the exploitation of selective wet etching solutions for a gradual transition from low-to-high refractive index contrast waveguide for reduced reflections. Moreover, the broadband operation of the device is promising for wavelength division multiplexing circuit operation. Finally, the fabrication errors are studied and shown not to add any notable losses as long as high precision lithography is used. The obtained results open a route to cheap packaging of large port count InP-based photonic integrated chips.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example, it is possible to make few considerations which can bring to further study of the structure for potential further improvement: (a) Reflections have been reported when removing the bottom InP cladding: it might be better to include the low-to-high RICT device only after a broadening of the input waveguide to reduce mode power loss into the bottom cladding. (b) One of the most critical steps is the placement of the InP/air interface. The use of selective wet etching solutions might offer a gradual transition from low-to-high refractive index contrast to mitigate the reflection problem at the InP/air interface. (c)

It is plausible that a complete and good transfer may be facilitated by a thicker PI on top of the InP waveguide: the exploitation of multi-layer polymer together with the partial removal of the top InP cladding and a longer tip taper may facilitate full power transfer. The final structure includes a free-standing 180 μm long waveguide with a polymer waveguide on top. Released structures, such as polymer cantilevers of a similar aspect ratio, can experience a form of residual-stress-induced upward bending. Therefore, this new structure is not expected to collapse. Furthermore, this stress induced curvature can be mitigated by using low energy ion bombardment in plasma. Alternatively, the process flow for obtaining this structure may consider spinning the polyimide after InP waveguide release, in order to obtain the final device completely embedded into the polymer and thus becoming even more robust.

All such variations are considered to be within the scope and spirit of the present invention as defined by the following claims and their legal equivalents.

What is claimed:

1) An optical waveguide coupler, comprising:
a) an InP substrate;
b) a guiding core layer disposed on said InP substrate;
c) a top cladding layer disposed on said guiding core layer, wherein said guiding core layer and said top cladding layer are disposed in a photosensitive housing waveguide; and
d) a mode coupling region comprising a lateral taper of said guiding core layer and said top cladding layer disposed above a region where said InP substrate is at least partially removed to create an air-cladding, wherein a low-to-high refractive index contrast transition (RICT) InP-based waveguide device is established to minimize light leakage into said InP substrate.

2) The optical waveguide coupler of claim 1, wherein said photosensitive housing waveguide comprises a photosensitive polymer material.

3) The optical waveguide coupler of claim 1, wherein said lateral taper of said top cladding comprises a fixed height, or a stepped height along a length of said top cladding layer.

4) The optical waveguide coupler of claim 1, wherein a boundary of said partially removed region of said InP substrate comprises a vertical boundary or an angled boundary.

5) The optical waveguide coupler of claim 1, wherein said guiding core layer comprises InGaAsP.

6) The optical waveguide coupler of claim 1, wherein said top cladding layer comprises InP.

7) The optical waveguide coupler of claim 1, wherein said photosensitive housing waveguide is disposed in a pattern on top of said InP-based waveguide.

8) The optical waveguide coupler of claim 1, wherein optical coupling is enabled by reducing a width of said guiding core layer and a width of said top cladding layer down to a fundamental mode cut-off condition of a guided beam, and by locally removing said bottom portion of said InP substrate layer that is at a position beginning along said reduced width and extending to a tip of said guiding core layer and said top cladding layer.

9) The optical waveguide coupler of claim 1, wherein a guided beam that is output from a tip of said guiding core layer is disposed to couple into a wider cross-section of said photosensitive housing waveguide and into a cleaved fiber.

10) The optical waveguide coupler of claim 1, wherein said lateral taper of said guiding core layer and said top cladding layer enable adiabatic coupling into said photosensitive housing waveguide, whereby broadband operation of said InP-based waveguide device is preserved.

11) The optical waveguide coupler of claim 1, wherein said lateral taper of said guiding core layer is configured to force a mode of a guided beam up into said photosensitive housing waveguide.
